(19) United States
(12) Patent Application Publication
(10) Pub. No.: US 2025/0065369 A1
(43) Pub. Date: Feb. 27, 2025

(54) HAPTIC ACTUATOR

(71) Applicant: KOREA ELECTRONICS TECHNOLOGY INSTITUTE, Seongnam-si (KR)

(72) Inventors: Hyung Won KANG, Seoul (KR); Seung Ho HAN, Seoul (KR); Intae SEO, Seongnam-si (KR)

(21) Appl. No.: 18/804,210

(22) Filed: Aug. 14, 2024

(30) Foreign Application Priority Data
Aug. 21, 2023 (KR) 10-2023-0109279

(51) Int. Cl. B06B 1/06

(52) U.S. Cl. CPC B06B 1/0648

(57) ABSTRACT

A haptic actuator is disclosed. The haptic actuator includes a piezoelectric element formed of a piezoelectric material, and a drive electrode formed at the piezoelectric plate to have a smaller area than an area of the piezoelectric plate. The haptic actuator minimizes reduction of a maximum displacement of the piezoelectric plate, as compared to reduction of drive current amount.

### CROSS-REFERENCE TO RELATED APPLICATION

The present application claims the benefit of priority to Korean Patent Application No. 10-2023-0109279, filed on Aug. 21, 2023 in the Korean Intellectual Property Office. The aforementioned application is hereby incorporated by reference in its entirety.

### BACKGROUND OF THE INVENTION

### Field of the Invention

The present disclosure relates to a haptic actuator.

### Description of the Related Art

Haptic technology provides tactile feedback such as vibration to a user. Generally, such haptic technology is applied to a smartphone, a joystick, a touchscreen, etc. Accordingly, when the user inputs a command, the device, to which the haptic technology is applied, may output tactile feedback corresponding to the command. In order to provide tactile feedback to the user, a haptic actuator is used. The haptic actuator may output mechanical movement upon receiving an electrical signal. The haptic actuator may include a piezoelectric element. When an electrical signal is applied to the piezoelectric element, the piezoelectric element may output a displacement through expansion or contraction. Using such displacement, tactile feedback may be provided.

### RELATED ART LITERATURE

### Patent Documents

Patent Document 1: KR 10-2015-0127523 A

### SUMMARY OF THE INVENTION

In accordance with an aspect of the present disclosure, it may be possible to provide a haptic actuator having a structure capable of minimizing reduction of a movement range while maximizing reduction of power consumption.

In accordance with the present disclosure, a haptic actuator includes a piezoelectric plate formed of a piezoelectric material, and a drive electrode formed at the piezoelectric plate to have a smaller area than an area of the piezoelectric plate.

In accordance with an embodiment, the piezoelectric plate may be formed to have a square shape.

In accordance with an embodiment, the drive electrode may include a plurality of inner electrodes formed at an interior of the piezoelectric plate, a first outer electrode formed at an upper surface of the piezoelectric plate, and a second outer electrode formed at a lower surface of the piezoelectric plate.

In accordance with an embodiment, the haptic actuator may further include a first connection pattern configured to interconnect the first outer electrode and a part of the plurality of inner electrodes, and a second connection pattern configured to interconnect the second outer electrode and a part of the plurality of inner electrodes.

In accordance with an embodiment, the drive electrode may be formed to have an area corresponding to 75% of the area of the piezoelectric plate.

In accordance with an embodiment, the drive electrode may be formed to cover a center of the piezoelectric plate.

In accordance with an embodiment, the drive electrode may include a central electrode configured to cover the center of the piezoelectric plate, and at least one ring electrode formed to have a concentric ring shape surrounding the central electrode while being disposed to be spaced apart from the central electrode.

In accordance with an embodiment, the drive electrode may be formed to have a square star structure covering the center of the piezoelectric plate while having a smaller area than the area of the square piezoelectric plate. The square star structure may have an octagonal shape protruding in four corner directions of the square piezoelectric plate while being concave in four side directions of the square piezoelectric plate.

In accordance with an embodiment, the drive electrode may be formed to have a square shape covering the center of the piezoelectric plate while having a smaller area than the area of the square piezoelectric plate.

In accordance with an embodiment, the drive electrode may be formed to have a circular shape covering the center of the piezoelectric plate while having a smaller area than the area of the square piezoelectric plate.

Prior to the description, it should be understood that the terms used in the specification and appended claims should not be construed as limited to general and dictionary meanings, but interpreted based on the meanings and concepts corresponding to technical aspects of the present disclosure on the basis of the principle that the inventor is allowed to define terms appropriately for best explanation.

### BRIEF DESCRIPTION OF THE DRAWINGS

Features and other advantages of the present disclosure will be more clearly understood from the following detailed description taken in conjunction with the accompanying drawings, in which:

FIG. 1 is a view showing a haptic actuator according to an embodiment of the present disclosure;

FIG. 2 is an exploded perspective view of the haptic actuator according to the embodiment of the present disclosure;

FIG. 3 is a cross-sectional view taken along line A-A′ in FIG. 1;

FIG. 4 is a view showing a circular drive electrode according to an embodiment;

FIG. 5 is a view showing a square drive electrode according to an embodiment;

FIG. 6 is a view showing a coaxial drive electrode according to an embodiment;

FIG. 7 is a view showing a square-star-shaped drive electrode according to an embodiment;

FIG. 8 is a view showing a square-ring-shaped drive electrode according to a comparative example; and

FIG. 9 is a view showing a double-ring-shaped drive electrode according to a comparative example.

### DETAILED DESCRIPTION OF THE INVENTION

In the specification, in adding reference numerals for elements in each drawing, it should be noted that like reference numerals already used to denote like elements in one drawing are also used to denote the elements in another drawing wherever possible.

It should be noted that terms used herein are merely used to describe a specific embodiment, not to limit the present disclosure. Incidentally, unless clearly used otherwise, singular expressions include a plural meaning.

It should be further understood that the terms “comprises”, “comprising”, “has”, “having”, “includes” and/or “including”, when used herein, specify the presence of stated features (for example, integers, functions, operations, or constituent elements such as components), but do not preclude the presence of other features.

In addition, the terms “one”, “the other”, “another”, “first”, “second”, etc. are used to differentiate one constituent element from another constituent element, and these constituent elements should not be limited by these terms.

Meanwhile, it should be understood that, when terms representing directions such as upwards, downwards, left, right, X-axis, Y-axis, Z-axis, etc. are used in the specification, these terms are merely for convenience of description, and such directions may be expressed differently from those represented by the terms, in accordance with the viewing position of an observer or the position at which an object is disposed.

It should be understood that there is no intent to limit the embodiments described in the present disclosure and the accompanying drawings to particular forms, but on the contrary, embodiments are to cover all modifications, equivalents, and alternatives falling within the spirit and scope of embodiments.

Hereinafter, exemplary embodiments of the present disclosure will be described in detail with reference to the accompanying drawings.

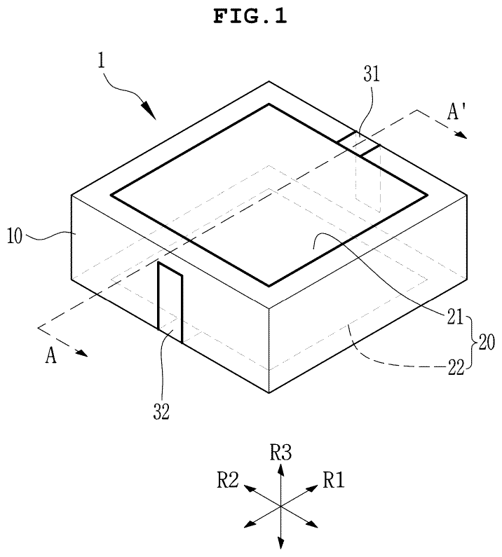

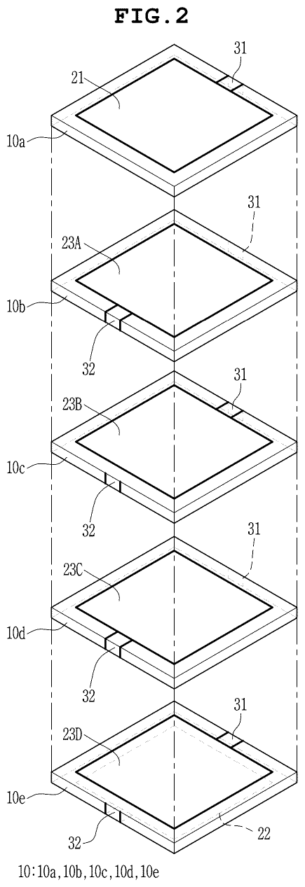

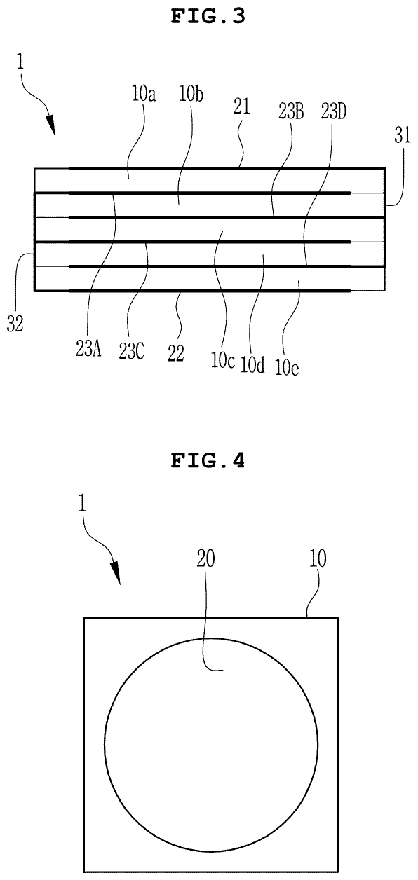

FIG. 1 is a view showing a haptic actuator 1 according to an embodiment of the present disclosure. FIG. 2 is an exploded perspective view of the haptic actuator 1 according to the embodiment of the present disclosure. FIG. 3 is a cross-sectional view taken along line A-A′ in FIG. 1.

The haptic actuator 1 according to the embodiment of the present disclosure may include a piezoelectric plate 10 formed of a piezoelectric material, and a drive electrode 20 formed at the piezoelectric plate 10 to have a smaller area than the area of the piezoelectric plate 10.

The piezoelectric plate 10, which is formed of a piezoelectric material, may be formed to have a thin plate shape. When electrodes are formed at opposite surfaces of the piezoelectric plate 10, respectively, and an electrical signal is input to the piezoelectric plate 10 through the electrodes, the piezoelectric plate 10 may generate a displacement through expansion or contraction thereof. The haptic actuator 1, which is a piezoelectric actuator, may apply an electrical signal to the piezoelectric plate 10 using the drive electrode 20 and, as such, may provide haptic feedback using expansion or contraction force of the piezoelectric plate 10.

The piezoelectric plate 10 may be formed to have a square shape. The piezoelectric plate 10 formed to have a square shape may expand and contract in surface directions R1 and R2 thereof.

The drive electrode 20 may be formed at the opposite surfaces of the piezoelectric plate 10. The drive electrode 20 may be formed at opposite surfaces of piezoelectric sub-plates 10a, 10b, 10c, 10d, and 10e. The drive electrode 20 may transmit an electrical signal to the piezoelectric plate 10. The drive electrode 20 may be formed of a material having electrical conductivity. The drive electrode 20 may be formed of copper (Cu), aluminum (Al), other metals, alloys thereof, indium tin oxide (ITO), a carbon structure, or other electrically-conductive materials.

The drive electrode 20 may include a plurality of inner electrodes 23 formed in an interior of the piezoelectric plate 10, a first outer electrode 21 formed at an upper surface of the piezoelectric plate 10, and a second outer electrode 22 formed at a lower surface of the piezoelectric plate 10. The first outer electrode 21 and the second outer electrode 22 are drive electrodes 20 formed at outermost sides of the piezoelectric plate 10, respectively. The inner electrodes 23 are drive electrodes 20 formed among the plurality of piezoelectric sub-plates 10a, 10b, 10c, 10d, and 10e.

The piezoelectric plate 10 may be formed to have a multilayer structure. The piezoelectric plate 10 may include a plurality of piezoelectric sub-plates 10a, 10b, 10c, 10d, and 10e stacked in one direction. The first outer electrode 21 and one of the inner electrodes 23, that is, an inner electrode 23A, may be disposed at opposite surfaces of the piezoelectric sub-plate 10a, respectively. The inner electrode 23A and another one of the inner electrodes 23, that is, an inner electrode 23B, may be disposed at opposite surfaces of the piezoelectric sub-plate 10b, respectively. Similarly, other ones of the inner electrodes 23 or another electrode 23 and the second outer electrode 22 may be disposed at opposite surfaces of a corresponding one of the piezoelectric sub-plates 10c, 10d, and 10e, respectively.

The first outer electrode 21, the second outer electrode 22, and the plurality of inner electrodes 23 may be formed to have the same shape. For example, all of the first outer electrode 21, the second outer electrode 22, and the plurality of inner electrodes 23 may be formed to have a circular shape.

The haptic actuator 1 may include a first connection pattern 31 configured to interconnect the first outer electrode 21 and a part of the plurality of inner electrodes 23, and a second connection pattern 32 configured to interconnect the second outer electrode 22 and a part of the plurality of inner electrodes 23. The connection patterns 31 and 32 may be formed of a material having electrical conductivity. The connection patterns 31 and 32 may be formed of the same material as that of the drive electrodes 20.

The first connection pattern 31 may be formed at one side of the piezoelectric plate 10, and the second connection pattern 32 may be formed at the other side of the piezoelectric plate 10. Among the plurality of inner electrodes 23, the inner electrodes 23 connected to the first connection pattern 31 and the inner electrodes 23 connected to the second connection pattern 32 are alternately disposed. For example, the first connection pattern 31 may interconnect the first outer electrode 21, the inner electrode 23B, and the inner electrode 23D, whereas the second connection pattern 32 may interconnect the inner electrode 23A, the inner electrode 23C, and the second outer electrode 22. The number of inner electrodes 23 may be greater than or smaller than four.

Meanwhile, when the piezoelectric plate 10 is formed through stacking of the plurality of piezoelectric sub-plates 10, as in the above-described embodiment, there is an advantage in that the piezoelectric plate 10 may be driven by a relatively low voltage, as compared to the case in which the piezoelectric plate 10 is constituted by one layer. However, when the number of piezoelectric sub-plates 10 increases, the number of inner electrodes 23 is increased and, as such, there may be a drawback in that the total capacitance of the drive electrode 20 may be increased, and an increase in drive current may occur.

The drive electrode 20 of the above-described embodiment may be formed to have a smaller area than the area of the piezoelectric plate 10. Since the drive electrode 20 of the embodiment is formed to have a smaller area than the area of the piezoelectric plate 10, it may be possible to reduce the total capacitance and to reduce the drive current.

Hereinafter, a shape of the drive electrode 20 according to an embodiment will be described with reference to FIGS. 4, 5, 6, and 7.

FIG. 4 is a view showing a circular drive electrode 20 according to an embodiment.

The circular drive electrode 20 according to this embodiment may be formed to have a circular shape covering a center of the piezoelectric plate 10 while having a smaller area than the area of the piezoelectric plate 10. The circular drive electrode 20 may be disposed to cover the center of the piezoelectric plate 10 which has a square shape. In this case, the center of the circular drive electrode 20 and the center of the square piezoelectric plate 10 may be concentrically disposed. The area of the circuit drive electrode 20 may be 70 to 80%, 60 to 90%, or 75% of the area of the square piezoelectric plate 10.

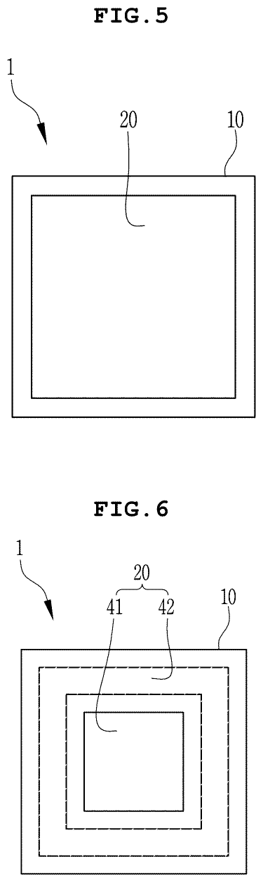

FIG. 5 is a view showing a square drive electrode 20 according to an embodiment.

The circular drive electrode 20 according to this embodiment may be formed to have a square shape covering a center of the piezoelectric plate 10 while having a smaller area than the area of the piezoelectric plate 10. The square drive electrode 20 may be disposed to cover the center of the piezoelectric plate 10 which has a square shape. In this case, the center of the square drive electrode 20 and the center of the square piezoelectric plate 10 may be concentrically disposed. The area of the square drive electrode 20 may be 70 to 80%, 60 to 90%, or 75% of the area of the square piezoelectric plate 10.

FIG. 6 is a view showing a coaxial drive electrode 20 according to an embodiment.

The drive electrode 20 according to this embodiment may include a central electrode 41 configured to cover a center of the piezoelectric plate 10, and at least one ring electrode 42 formed to have a concentric ring shape surrounding the central electrode 41 while being disposed to be spaced apart from the central electrode 41. The drive electrode 20 described above may be referred to as a “coaxial drive electrode 20”. The central electrode 41 may have a square shape or a circular shape. The ring electrode 42 may have a square shape or a circular shape. The central electrode 41 and the ring electrode may be interconnected through a third connection electrode. The third connection electrode may be formed in a space between the central electrode 41 and the ring electrode 42 and, as such, may interconnect the central electrode 41 and the ring electrode 42. The coaxial drive electrode 20 may be disposed such that the central electrode 41 covers the center of the piezoelectric plate 10. The center of the central electrode 41 and the center of the square piezoelectric plate 10 may be concentrically disposed. The area of the coaxial drive electrode 20 may be equal to the sum of the area of the central electrode 41 and the area of the ring electrode 42. The area of the coaxial drive electrode 20 may be 70 to 80%, 60 to 90%, or 75% of the area of the square piezoelectric plate 10.

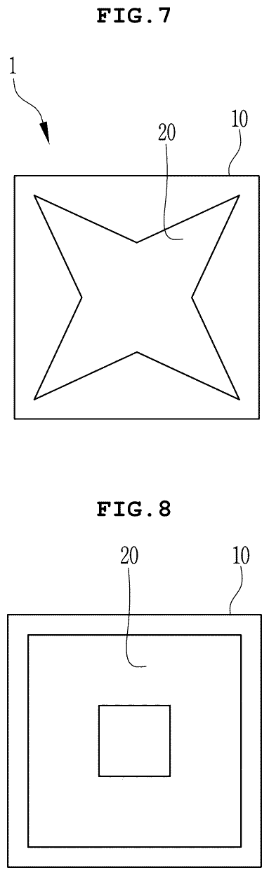

FIG. 7 is a view showing a square-star-shaped drive electrode 20 according to an embodiment.

The drive electrode 20 according to this embodiment may be formed to have a square star structure covering a center of the piezoelectric plate 10 while having a smaller area than the area of the square piezoelectric plate 10. The square star structure has an octagonal shape protruding in four corner directions of the square piezoelectric plate 10 while being concave in four side directions of the square piezoelectric plate 10. The square-star-shaped drive electrode 20 has an octagonal shape having four convex corners and four concave corners. The square-star-shaped drive electrode 20 may be formed at the square piezoelectric plate 10 such that the four convex corners thereof face four corners of the square piezoelectric plate 10, respectively, and the four concave corners thereof face four sides of the square piezoelectric plate 10, respectively. The square-star-shaped drive electrode 20 may be disposed to cover the center of the square piezoelectric plate 10. The center of the square-star-shaped drive electrode 20 and the center of the square piezoelectric plate 10 may be concentrically disposed. The area of the square-star-shaped drive electrode 20 may be 70 to 80%, 60 to 90%, or 75% of the area of the square piezoelectric plate 10.

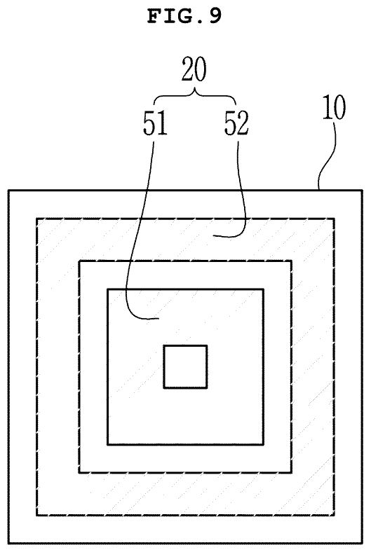

FIG. 8 is a view showing a square-ring-shaped drive electrode 20 according to a comparative example. FIG. 9 is a view showing a double-ring-shaped drive electrode 20 according to a comparative example.

The square-ring-shaped drive electrode 20 is formed to have a shape in which a center of a square plate is not covered by an electrode. Similarly, the double-square-ring shape drive electrode 20 is formed to have a shape in which a center of a square plate is not covered by an electrode. The double-square-ring shape drive electrode 20 is formed to include an inner ring electrode 51 and an outer ring electrode 52 spaced apart from each other and to be concentric with respect to the center of the square plate.

Results of experiments for a maximum displacement ratio according to an area of the square piezoelectric plate 10, a shape of the drive electrode 20, and an area of the drive electrode 20 are shown in Table 1.

TABLE 1

Maximum Displacement Ratio [%]

| Area | Square | Square Ring | Coaxial | Double- |
|---|---|---|---|---|
| Ratio[%] | Shape | Shape | Shape | Ring Shape |
| 50 | 69.2 | 44.1 | 63.5 | 61.6 |
| 66.7 | 82.8 | 65.1 | 79.8 | 77.7 |
| 75 | 88.8 | 76.8 | 86.4 | 83.9 |

The area ratio represents a percentage of the area of the drive electrode 20 with reference to the area of the square piezoelectric plate 10 (100%). In association with the area ratio, 50% means ½ of the area of the square piezoelectric plate 10, 66.7% means ⅔ of the area of the square piezoelectric plate 10, and 75% means ¾ of the area of the square piezoelectric plate 10. The maximum displacement ratio represents a percentage of a maximum displacement generated when the drive electrode 20, which has a particular shape and a particular area, is formed at the square piezoelectric plate 10 with reference to a maximum displacement generated when the entirety of the square piezoelectric plate 10 is covered by the drive electrode 20 (100%). The area ratio is proportional to a capacitance of the drive electrode 20 and an amount of drive current consumed by the drive electrode 20. Since capacitance is proportional to area and, as such, when the area ratio is 50%, the capacitance may be about 50%, and the amount of drive current may also be about 50%. However, it is necessary to minimize reduction of the maximum displacement ratio while maximizing reduction of the amount of drive current, in order to use the resultant structure as the haptic actuator 1.

Referring to Table 1, it may be seen that, when maximum displacement ratios are measured under the condition that only the areas of the drive electrodes 20 having the same shape are different from one another, the case having an area ratio of 75% exhibits a greater maximum displacement ratio than those of the cases respectively having area ratios of 50% and 66.7%. For example, the square drive electrode 20 may exhibit a maximum displacement ratio of 69.2% when the area ratio thereof is 50%, may exhibit a maximum displacement ratio of 82.8% when the area ratio thereof is 66.7%, and may exhibit a maximum displacement ratio of 88.8% when the area ratio thereof is 75%. When the area ratio is 75%, the amount of drive current may be reduced by 25%, whereas the maximum displacement ratio may be reduced only by 11.2%. Similarly, in the cases of the square ring shape, the coaxial shape, and the double-ring shape, it may be possible to minimize reduction of the maximum displacement ratio, as compared to reduction of the amount of drive current, when the area ratio is 75%.

In association with the shape of the drive electrode 20, among the square shape, the square ring shape, the coaxial shape, and double-ring shape, the square shape and the coaxial shape exhibit a great maximum displacement ratio under the condition that the area ratio is constant. Each of the square shape and the coaxial shape is a shape in which the drive electrode 20 covers the center of the piezoelectric plate 10. On the other hand, each of the square ring shape and the double-ring shape is a shape in which the driver electrode 20 does not cover the center of the piezoelectric plate 10.

Referring to Table 1, it may be seen that the square drive electrode 20 exhibits a greatest maximum displacement ratio, as compared to the drive electrodes 20 of other shapes. Table 2 shows maximum displacement ratios of the square drive electrode 20, the circular drive electrode 20, and the square-star-shaped drive electrode 20 according to area ratios thereof.

TABLE 2

| | Maximum Displacement Ratio [%] | | |
|---|---|---|---|
| Area | Square | Circular | Square |
| Ratio[%] | Shape | Shape | Star Shape |
| 50 | 69.2 | 69.5 | 68.7 |
| 66.7 | 82.8 | 83.4 | 81.5 |
| 75 | 88.8 | 89.4 | 88.0 |
| 79.3 | | 91.0 | |

Referring to Table 2, it may be seen that, even in the cases of the square, circular, and square-star-shaped drive electrodes 20, reduction of the maximum displacement ratio is minimized and reduction of the amount of drive current is maximized when the area ratio is 75%. In particular, it may be seen that a maximum displacement ratio of 89.4% is exhibited when the area ratio is 75%, and a maximum displacement ratio of 91.0% is exhibited when the area ratio is 79.3%. In detail, the amount of drive current is reduced by 25% and the maximum displacement ratio is reduced by 10.6% when the area ratio is 75%, whereas the amount of drive current is reduced by 20.7% and the maximum displacement ratio is reduced by 9% when the area ratio is 79.3%. That is, the ratio of the drive current amount reduction to the maximum displacement ratio reduction when the area ratio is 79.3% (20.7/9=2.3) is smaller than the ratio of the drive current amount reduction to the maximum displacement ratio reduction when the area ratio is 75% (25/10.6=2.36). That is, when the area ratio is 75%, the amount of drive current is maximally reduced, and the maximum displacement ratio is minimally reduced. In association with the shape of the drive electrode 20, among the square shape, the circular shape, and the square star shape, the circular shape exhibit a greatest maximum displacement ratio under the condition that the area ratio is constant. The circular shape, the square shape, and the square star shape exhibit result values of similar ranges on the whole. That is, the drive electrodes 20 of the circular shape, the square shape, and the square star shape exhibit great maximum displacement ratio differences from those of the drive electrodes 20 of the square ring shape and the double-ring shape of the comparative examples. In this regard, it may be seen that the shape in which the drive electrode 20 covers the center of the piezoelectric plate 10 is a shape capable of reducing reduction of a maximum displacement ratio.

Accordingly, the drive electrode 20 according to each embodiment may be formed to have an area corresponding to 75% of the area of the piezoelectric plate 10 and to cover the center of the piezoelectric plate 10.

As apparent from the above description, in accordance with the embodiments of the present disclosure, it may be possible to not only reduce consumption of current, but also to minimize reduction of a displacement, by reducing an electrode area of the haptic actuator.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

1. A haptic actuator comprising:
a piezoelectric plate formed of a piezoelectric material; and
a drive electrode formed at the piezoelectric plate to have a smaller area than an area of the piezoelectric plate.

2. The haptic actuator according to claim 1, wherein the piezoelectric plate is formed to have a square shape.

3. The haptic actuator according to claim 1, wherein:
the drive electrode comprises:
a plurality of inner electrodes formed at an interior of the piezoelectric plate;
a first outer electrode formed at an upper surface of the piezoelectric plate; and
a second outer electrode formed at a lower surface of the piezoelectric plate; and
the haptic actuator further comprises:
a first connection pattern configured to interconnect the first outer electrode and a part of the plurality of inner electrodes; and
a second connection pattern configured to interconnect the second outer electrode and a part of the plurality of inner electrodes.

4. The haptic actuator according to claim 2, wherein the drive electrode is formed to have an area corresponding to 75% of the area of the piezoelectric plate.

5. The haptic actuator according to claim 2, wherein the drive electrode is formed to cover a center of the piezoelectric plate.

6. The haptic actuator according to claim 5, wherein the drive electrode comprises:
a central electrode configured to cover the center of the piezoelectric plate; and
at least one ring electrode formed to have a concentric ring shape surrounding the central electrode while being disposed to be spaced apart from the central electrode.

7. The haptic actuator according to claim 5, wherein the drive electrode is formed to have a square star structure covering the center of the piezoelectric plate while having a smaller area than the area of the square piezoelectric plate, the square star structure having an octagonal shape protruding in four corner directions of the square piezoelectric plate while being concave in four side directions of the square piezoelectric plate.

8. The haptic actuator according to claim 5, wherein the drive electrode is formed to have a square shape covering the center of the piezoelectric plate while having a smaller area than the area of the square piezoelectric plate.

9. The haptic actuator according to claim 5, wherein the drive electrode is formed to have a circular shape covering the center of the piezoelectric plate while having a smaller area than the area of the square piezoelectric plate.
